(19) United States
(12) Patent Application Publication
(10) Pub. No.: US 2016/0311650 A1
(43) Pub. Date: Oct. 27, 2016

(54) ADAPTIVE REMOTE MONITORING REPORTING

(71) Applicant: KONE Corporation, Helsinki (FI)

(72) Inventors: Jani HAUTAKORPI, Vantaa (FI); Hannu RYTILÄ, Hyvinkaa (FI)

(73) Assignee: KONE Corporation, Helsinki (FI)

(21) Appl. No.: 15/202,038

(22) Filed: Jul. 5, 2016

Related U.S. Application Data
(63) Continuation of application No. PCT/FI2014/050160, filed on Mar. 4, 2014.

(51) Int. Cl. B66B 5/00; H04L 12/58

(52) U.S. Cl. CPC B66B 5/0018; H04L 51/26

(57) ABSTRACT

An elevator is equipped with a plurality of remote monitoring sensors for detecting faults and other events in a variety of components in the elevator. These remote monitoring sensors produce remote monitoring messages having a priority classification according to the fault or monitoring event severity. These remote monitoring messages are processed according to the priority classification and available communication connection properties. Based on the processing the communication connection for transmitting the remote message to a central system is selected and sent or temporarily stored for later transmittal.

### FIELD OF THE INVENTION

The invention relates to remote monitoring reporting in an elevator system.

### BACKGROUND OF THE INVENTION

In many countries every elevator has to have an emergency telephone. As the regulation is old in vast majority of the elevators installed in the world the emergency phone is an ordinary PSTN-telephone (public switched telephone network) that is connected to an emergency center. In modern installations the PSTN-telephone may have been replaced by, for example, a GSM-telephone that is correspondingly connected to the emergency center.

When the emergency telephone is not used for emergency calls the same telephone connection may be used for data transfers. For example, there may be a plurality of remote monitoring sensors in the elevator and whenever a fault or monitoring event occurs the elevator may transmit a fault or remote monitoring report to a central system collecting reports by making a modem call over the PSTN-connection. These reports are then processed accordingly and if there is a need for a maintenance operation detected based on the received remote monitoring reports a person may be sent to check these cause of the report.

The drawbacks of the prior art the remote monitoring reporting systems are capable of managing only one connection type even if the elevator may include a plurality of connection types, for example, for entertainment or informative purposes. A further drawback of the prior art is that the prior art implementations are not capable of handle remote monitoring report properties, for example regarding the urgency and data size.

### SUMMARY

An elevator is equipped with a plurality of remote monitoring sensors for detecting faults and performing other remote monitoring tasks in a variety of components in the elevator. These remote monitoring sensors produce fault and other remote monitoring messages having a priority classification according to the fault severity or importance of the monitoring event. These messages are processed according to the priority classification and available communication connection properties. Based on the processing the communication connection the message to a central system is selected and sent.

In an embodiment of the invention the invention is implemented as a method for adaptive remote monitoring data reporting. In the method first a message comprising priority classification is received from a component in an elevator. Then the priority classification is extracted from the received message. Based on the extracted priority classification and properties of connection types available the connection type for the message selected. Lastly, the message is sent over the selected connection.

In another embodiment the message is received from a remote monitoring sensor incorporated with a component in the elevator or from an emergency phone. In a further embodiment messages having a priority lower than a predetermined threshold priority are stored temporarily in a memory for later transmitting. The stored messages can be transmitted after the number of messages exceeds the predetermined threshold number, after receiving a message exceeding the predetermined threshold priority or after an expiration of a predetermined time period. In a further embodiment, when the elevator is arranged with bi-directional communication means a maintenance person may request all messages to be transmitted when he is planning to visit the elevator. Thus, the maintenance person has all necessary information and can prepare accordingly.

In an embodiment of the invention the method discussed above is implemented as a computer program stored on a computer readable medium. When the computer program is executed in a computing device it will cause the method discussed above.

In an embodiment of the invention the method is performed by an apparatus comprising a plurality of communication connections for transmitting messages and at least one communication connection for receiving messages. The apparatus further comprises a memory for storing data and computer program code and a processor for executing computer program code and for processing data in accordance with computer programs executed in the apparatus. In a further embodiment the apparatus is installed in an elevator car.

The benefits of the invention include a fluent processing of remote monitoring messages and efficient use of available communication means. This provides faster response when it is needed. Furthermore, the present invention allows cost savings when regulations not require a specific connection type for the messages.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram of an example embodiment of the present invention, and

FIG. 2 is a flow chart of an example embodiment of the present invention.

### DETAILED DESCRIPTION OF THE INVENTION

Reference will now be made in detail to the embodiments of the present invention, examples of which are illustrated in the accompanying drawings.

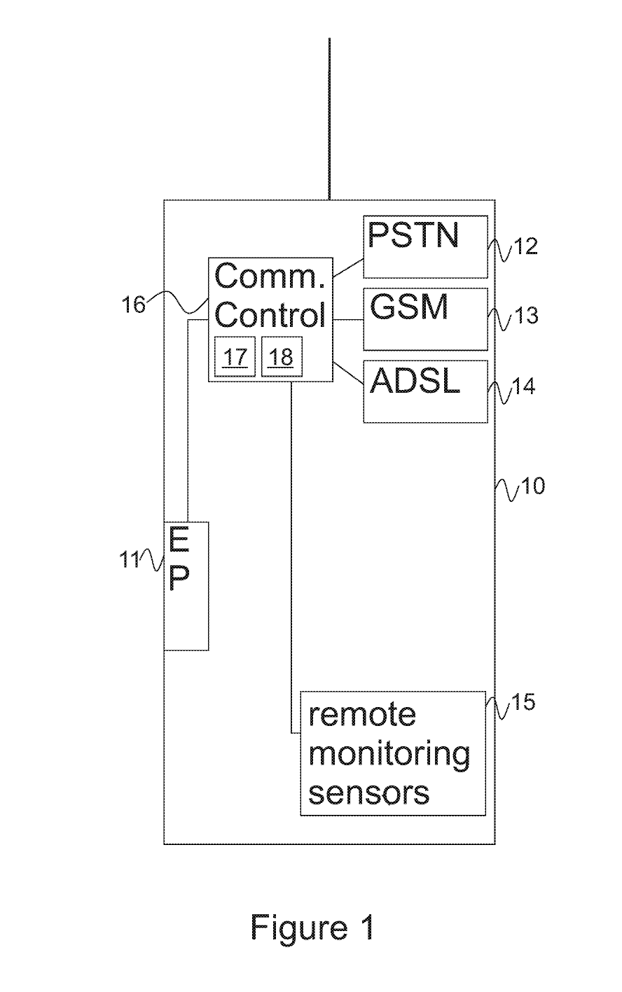

In FIG. 1 a flow chart a block diagram of an embodiment of the present invention. In the example an elevator 10 is disclosed. The elevator 10 is an ordinary elevator that may be located in an elevator group comprising a plurality of elevators or it may be a stand-alone installation.

As described above the elevator 10 comprises an emergency phone 11. The emergency phone may be connected directly to the public switched telephone network (PSTN) 12 but in the example embodiment all communications are arranged through communication controller 16. The emergency phone 11 is a mandatory device and it is installed in all elevators.

In addition to the PSTN-connection the example embodiment of FIG. 1 includes GSM 13 and ADSL 14 connections but the invention is not limited to these, but for example Wireless LAN, Long Term Evolution (LTE), Ethernet, or any other suitable network connection may be used. In conventional implementations only PSTN-connection was present but the present invention works with any combination of network connections. The telecommunication and/or data communication connections are connected to the communication controller 16. The communication controller is configured to receive messages from devices and components installed to the elevator. The controller 16 comprises a memory 17 for storing the messages and a processor 18 for processing the messages. The messages are processed in accordance with the priority classification included in the message.

The messages mentioned above are received from remote monitoring sensors 15. For the sake of the clarity the sensors are illustrated as a one block in the figure, however, typically these sensors are located in multiple locations. For example, there may be a sensor monitoring lighting in order to detect defect lights, or there may be a sensor for detecting the display of the control device. More important messages come from the sensors monitoring systems involving the security of the device. For example, if the elevator has stopped between floors a message with higher priority is received. A modern elevator installation has a large number of possible remote monitoring targets that need to be monitored and reported. As discussed above not all of the remote monitoring data relate to security issues but may relate only to maintenance of the elevator. Also these messages may be prioritized. For example, if there is a fault that is likely to cause further faults it should be fixed at the earliest convenience. However, if the fault is not likely to cause further faults and does not cause a security problem itself it may be repaired during the next maintenance. A further criterion for priority may be the user experience. For example, even if lighting is not likely to cause further faults or security problems, it causes inconvenience to passengers and the elevator operator may wish to repair it immediately in order to provide the best possible passenger experience. A special example of a message is an emergency call. The call is initiated with the emergency phone 11 and it is typically configured with the highest priority.

Communication controller 16 receives messages with priority classification as discussed above. Then, the communication controller 16 makes a decision which communication connection 12-14 to use. The decision is based on the properties of the communication connection and the message to be transferred. For example, in the special case of the emergency call it is obvious that the call must be done immediately. Typically PSTN, GSM or other common telecommunication connection used for telephone calls is chosen because of the established systems and liability issues. Other messages, such as fault messages, may be sent over ADSL as it typically has a fixed price whereas PSTN-connection is typically charged according to the need, for example based on the connection time.

In an embodiment of the invention all data communication connections involve an initiation fee for transfer. In other words, the data communication connection must be opened separately for every transmission and each communication is billed accordingly. In such cases the communication controller 16 may collect messages and send them, for example, when a predetermined number of messages have been stored into memory 17 of the communication controller 16. Instead of predetermined number a predetermined interval may be used, for example, once in a week. The system may be further configured such that when remote monitoring messages of predetermined priority level occur the messages are sent immediately. The system may be further configured such that the emergency calls are not taken into account in transmission of other messages as it is important that in case of emergency the call is not disturbed.

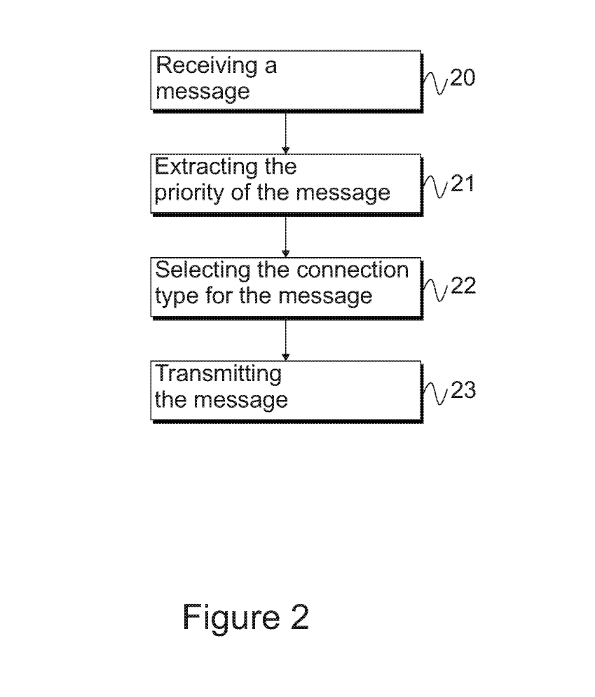

In FIG. 2 a method disclosing an embodiment according to the present invention is disclosed. In the embodiment the method is performed in an elevator system, such as the elevator car of FIG. 1. In the beginning at least one message is received, step 20. The message is received from a component in the elevator system. The message according to the invention includes a priority classification. The priority classification is then extracted from the message, step 21. Based on the priority classification and properties of difference communication connections available the communication connection is chosen for the message, step 22. The properties mentioned above include, for example, the connection type, pricing, bandwidth, liability issues and similar. For example, the communication connection may have a fee for opening the connection or fee based on the transferred data. Properties mentioned above are stored into a memory and associated with each of the connections respectively. When the connection type is chosen it is used for transmitting the message, step 23.

In a further embodiment transmitting is delayed when the priority classification does not exceed predetermined threshold. In that case messages are stored into a memory for later transmittal. The later transmittal may be triggered, for example, when a connection is opened for a message having higher priority, a predetermined number of delayed messages is reached or a predetermined time period expires. It is possible to determine the sending order according to the need. For example, the message with priority classification high enough to trigger transmittal is transmitted first and then delayed messages are transmitted in the order of storage or in the order of priority.

In an embodiment the controller 16 of FIG. 1 comprises at least one processor 18 and at least one memory 17, wherein the memory 17 includes computer program code for one or more programs, the at least one memory and the computer program code are working together, with the at least one processor 18, cause the controller, or other similar apparatus, to perform a method disclosed above with referral to FIG. 2. The software is embodied on a computer readable medium so that it can be provided to the computing device.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the invention may be implemented in various ways. The invention and its embodiments are thus not limited to the examples described above; instead they may vary within the scope of the claims.

1-18. (canceled)

19. A method for adaptive remote monitoring reporting which method comprises:
receiving a message comprising priority classification from a component in an elevator;
extracting the priority classification from said received message;
selecting the connection type for the message based on said extracted priority classification and
properties of connection types available;
transmitting said message over said selected connection,
wherein said messages having a priority lower than a predetermined threshold priority are stored temporarily in a memory for later transmitting.

20. The method according to claim 19, wherein said message is received from a remote monitoring sensor incorporated with a component in said elevator.

21. The method according to claim 19, wherein said message is received from an emergency phone.

22. The method according to claim 19, wherein transmitting said temporarily stored messages after the number of messages exceeds the predetermined threshold number.

23. The method according to claim 19, wherein transmitting said temporarily stored messages after receiving a message exceeding the predetermined threshold priority.

24. The method according to claim 19, wherein transmitting said temporarily store messages after an expiration of a predetermined time period.

25. The method according to claim 19, wherein the method further comprises receiving a request to transmit stored messages and transmitting stored messages as a response to the request.

26. A computer program comprising code adapted to cause the method according to claim 19 when executed on a computing system.

27. An apparatus comprising:
at least one communication connection for receiving messages;
a memory for storing computed program code and said received messages;
a processor for executing computer program code and processing said received messages; and
at least two communication connections for transmitting said processed messages,
wherein the apparatus is configured to: receive a message comprising priority classification from a component in an elevator car;
extract the priority classification from said received message;
select the connection from said at least two communication connections for transmitting for the message based on said extracted priority classification and properties of connection types available;
transmitting said message over said selected connection,
wherein said messages having a priority lower than a predetermined threshold priority are stored temporarily in said memory for later transmitting.

28. The apparatus according to claim 27, wherein said message is received from a remote monitoring sensor incorporated with a component in said elevator.

29. The apparatus according to claim 27, wherein said message is received from emergency phone.

30. The apparatus according to claim 27, wherein the apparatus is configured to transmit said temporarily stored messages after the number of messages exceeds the predetermined threshold number.

31. The apparatus according to claim 27, wherein the apparatus is configured to transmit said temporarily stored messages after receiving a message exceeding the predetermined threshold priority.

32. The apparatus according to claim 27, wherein the apparatus is configured to transmit said temporarily store messages after an expiration of a predetermined time period.

33. The apparatus according to claim 27, wherein the apparatus is further configured to receive a request to transmit stored messages and to transmit stored messages as a response to the request.

34. An elevator comprising an apparatus according to claim 27.

35. The method according to claim 20, wherein transmitting said temporarily stored messages after the number of messages exceeds the predetermined threshold number.

36. The method according to claim 21, wherein transmitting said temporarily stored messages after the number of messages exceeds the predetermined threshold number.

37. The method according to claim 20, wherein transmitting said temporarily stored messages after receiving a message exceeding the predetermined threshold priority.

38. The method according to claim 21, wherein transmitting said temporarily stored messages after receiving a message exceeding the predetermined threshold priority.
